(19) United States
(12) Patent Application Publication
(10) Pub. No.: US 2002/0188464 A1
(43) Pub. Date: Dec. 12, 2002

(54) Method and system for marketing and conducting a survey

(76) Inventor: Marc Hodgins, Calgary (CA)

Correspondence Address: Santosh K. Chari, Orange & Chari, 66 Wellington Street West, Suite 4900, P.O. Box 4900, Toronto, ON, M5K 1H6, CA

(21) Appl. No.: 10/161,656

(22) Filed: Jun. 5, 2002

Related U.S. Application Data
(60) Provisional application No. 60/295,810, filed on Jun. 6, 2001.

(51) Int. Cl. G06F 17/60

(52) U.S. Cl. 705/1; 705/10

(57) ABSTRACT

A method and system for marketing and/or conducting a survey includes the distribution of cards at a selected event to one or more individuals. The cards indicate contact information whereby the individuals are able to contact a host, such as a server connected to a network, conducting said marketing or conducting said survey. The cards also include a unique identifier associated with the event whereby the host is able to differentiate the individuals based on the event they have attended. The host also includes an information exchange system wherein the individuals first enter the unique identifier and, subsequently, further demographic data. The individuals are provided an incentive in the form of a contest or prize for contacting the host.

### BACKGROUND OF THE INVENTION

1. Field of the Invention

The present invention relates generally to an incentive based method for marketing products or services and/or for conducting demographic surveys.

2. Description of the Prior Art

Various methods have been developed for the marketing of products or services. Many of such methods involve the provision of an award or incentive for attracting the potential customer to the respective product or service.

An example of one such method is described in U.S. Pat. No. 6,173,267, which discloses a method for product promotion. This reference teaches a method wherein purchasers of a product are directed to a web site upon purchasing a product. This is achieved by means of a card, for example, that is placed in or on the product. The card directs the purchaser to access a particular web site in order to determine whether they have won a sweepstakes contest. By means of an entry form on the web site, demographic data on the purchaser can also be obtained. Thus, this method relates to a means of promoting a particular product and then obtaining certain information on the purchasers of such product.

U.S. Pat. No. 5,749,075 teaches a method for promoting a telephone calling card by offering a promotion. The promotion consists of a period of free calling time. In order to activate the card, the user must access a web site and enter certain demographic data. As above, this method relates to the promotion of a specific service and then obtaining information of those who avail themselves of such service.

Thus, there is a need for a more multi-purpose marketing and surveying method using a computer network.

### SUMMARY OF THE INVENTION

In one aspect, the invention provides a method of marketing and/or conducting a survey amongst individuals attending a common event, said marketing or surveying being conducted by a host, said method comprising:

a) distributing cards at the event, said cards indicating contact information for contacting the host and a unique identifier identifying the event;

b) encouraging said individuals to contact said host; and

c) obtaining desired information from said individuals.

In another aspect, the invention provides a system for marketing and/or conducting a survey amongst individuals attending a common event, said marketing or surveying being conducted by a host, said system comprising:

a) a host capable of being contacted by said individuals over a communication system; and,

b) one or more cards distributed to said individuals, said cards indicating contact information for contacting the host and a unique identifier identifying said event.

In yet another aspect, the invention provides A system for marketing and/or conducting a survey amongst individuals attending a common event, said system comprising:

a) a computer network;

b) a host conducting said marketing or surveying, said host being connected to said computer network;

c) one or more cards distributed to said individuals, said cards indicating contact information for contacting the host and a unique identifier identifying said event;

d) said host including an interface for exchanging information with said individuals.

### BRIEF DESCRIPTION OF THE DRAWINGS

These and other features of the preferred embodiments of the invention will become more apparent in the following detailed description in which reference is made to the appended drawings wherein:

FIG. 1 is a schematic representation of a survey method according to an embodiment of the invention.

### DESCRIPTION OF THE PREFERRED EMBODIMENTS

The present invention provides a web-based marketing and demographics acquisition method that is “target specific” to particular events. According to the invention, an “event” is defined as any type of public or private event such as a music concert, exhibition or other such venue where people attend. Examples of events can include, but are not limited to: Schools or school events; Conferences, camps and clubs; Music concerts, tours and festivals; Live performances and celebrity appearances; In-store events (e.g. CD releases, listening parties, celebrity appearances etc); Amusement parks; Sports events; Night clubs; Restaurants; Tourist attractions; Malls and shopping centres; Parades, festivals and other outdoor events; Recreation centres; Movie theatres; Public exhibitions; and Private parties.

According to a preferred embodiment of the invention, attendees at an event, for example as described above, are provided a unique “event code” and an internet URL and are instructed to visit the web site corresponding to the URL. In a preferred embodiment, the event code and URL are provided to the attendee by means of a card that can be handed out before, during or after the event.

The event code is a unique identifier that identifies the specific event where the card is handed out to the attendee. The event code may comprise any type of identifier such as a numeric, alphanumeric, or alphabetic code etc., such as “E5Z23R”, wherein the code can be decoded to identify the specific event. Alternatively, the event code may simply be a text describing the event itself such as: “CONCERT-CALGARY”.

Upon accessing the URL and entering the event code, the user/attendee is prompted to enter specific information pertaining to the user. Such information may comprise demographic, geographic, contact or other such information that may be gathered in the form of an entry screen or a survey type of system. The information is then collected and passed to the event organizers, promoters, or other such entities. The information enables the organizers/promoters to create mailing lists, and/or obtain information concerning the interests etc. of attendees of a particular event. For example, the method enables a concert promoter to obtain demographic data concerning the attendees of a music concert wherein the data may include specifics of the gender, age and other interests of the attendees. Such data will then assist the promoter in further marketing efforts and/or in creating a mailing list for related activities. The information or data can also be used for profiling the attendees (in an aggregate or individual manner), for market research or for direct marketing. In another embodiment, the information gathered may comprise contact data such as email addresses, telephone/fax numbers etc. that would enable the creation of a mailing or contact list.

The event code described above, enables the data or information gathered from attendees to be specifically differentiated from one event to the other. In other words, since a event code is unique to a particular event (where the card is handed out), the event code entered by the attendee upon accessing the web site will differentiate the information entered by such attendee from information entered by an attendee of another event, despite each individual accessing the same URL. It will be understood by persons skilled in the art that it is not necessary to have a common URL and that any number of URLs may be used in the method depending upon specific needs.

By using an event code as indicated above, the method also serves to prevent accidental access to the web site, or URL, since in order to access the site, a specific event code is required.

In addition, the URL may include a “time out” feature wherein access to the site using a particular event code may only be provided for a few months after a specific event. In this manner, administration of the site is facilitated.

The attendees at a particular event may be encouraged to access the URL by means of incentives such as a prize or sweepstakes contest etc., which to be entitled to win, the attendee must claim or enter by accessing the site. Prior to obtaining the prize or being entitled to qualify, the attendee must enter the event code and the desired data or information as described above.

In another embodiment, the cards described above may also have marketing material printed thereon. In this manner, the card itself may act as a marketing tool.

In another embodiment, the card described above may be provided inside the packaging of specific products. In this manner, the method of the invention may be used to market to, or profile the purchasers of a specific product or, in other cases, service.

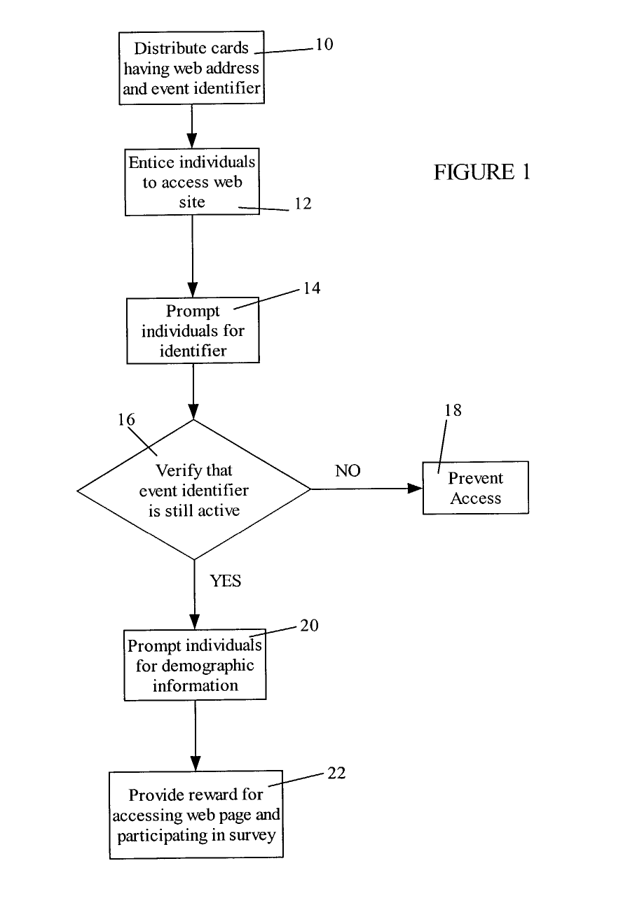

An example of the above described survey method is illustrated in FIG. 1. It will be understood that this example is merely provided to illustrate an embodiment of the invention and is not intended to limit the invention in any way. As shown, the method begins with the distribution, 10, of event cards at a specific event. The cards can be distributed in any manner to either volunteers, or select individuals. The cards will include a web address for the individuals to access as well as a unique event identifier. As indicated above, each event will preferably be provided with a separate identifier.

In the preferred embodiment, an individual will be enticed, 12, to access the web site. Such enticement can comprise a prize or award or entrance into a contest wherein the winner obtains a prize or award.

Once the individual enters the web site, they are first prompted, 14, to enter the event identifier. The event identifier is then verified, 16, to ensure that the maximum time limit for accessing the site has not passed. If the time limit has passed, the individual is advised, 18, of such and prevented from further access to the site. However, if the time limit has not passed, then the individual is allowed into the web site.

In the next step, 20, the individual is requested to enter certain demographic data. Such data can comprise any type of information that is required for the survey being conducted. The amount and type of information will, of course, depend on the specific purpose of the survey. The collected information is then processed as needed.

Once the required information has been obtained, the individual is provided, 22, a reward. As explained above, the reward may consist of a prize or an entrance into a contest to win a prize. As an example, and as discussed further below, the reward may consist of digital photographs taken at the event, which the individuals may freely access and save.

As explained above, both the cards and the web site can be provided with marketing information, such as advertisements, logos etc, for one or more products or services.

Although the above discussion has been focussed on a preferred embodiment wherein the attendees are required to access a URL over the internet, it will also be appreciated by persons skilled in the art that the present invention can easily be adapted for use using a telephone, cell phone, wireless system (e.g. wireless application protocol, WAP), or other electronic or handheld systems (such as personal digital assistants, PDAs) etc. For example, in the case of a telephone or cell phone system, the user/attendee is able to access a central server and enter the same type of information as described above but using the dial pad or a voice recognition software instead. Further, although the access of a URL over the internet has been described, it will be appreciated that any type of computer network, including wireless networks, LANs or WANs, may be equally used.

In another embodiment, the invention provides a method of selling product over a network using the above mentioned cards. In this embodiment, an individual attending an event such as a dance or concert etc. can be provided with a card with an event code as described above. The individual can then access a collection of, for example, digital photographs taken at the event, and can purchase such photographs. It will be appreciated that other similar products can be sold in the same manner. In another embodiment, the digital photographs taken at the event can be placed on the web site for free access as a means of rewarding individuals for participating.

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A method of marketing and/or conducting a survey amongst individuals attending a common event, said marketing or surveying being conducted by a host, said method comprising:
a) distributing cards at the event, said cards indicating contact information for contacting the host and a unique identifier identifying the event;
b) encouraging said individuals to contact said host; and
c) obtaining desired information from said individuals.

2. The method of claim 1 wherein said host is a host computer and said contact information comprises a URL address for said host computer.

3. The method of claim 2 wherein said URL address directs said individuals to a web site on said host computer.

4. The method of claim 1 wherein said unique identifier comprises an alpha numeric code.

5. The method of claim 1 wherein said step of encouraging said individuals comprises offering incentives.

6. The method of claim 1 wherein said desired information comprises demographic data of said individuals.

7. The method of claim 1 wherein said card includes marketing information for one or more products or services.

8. The method of claim 2 wherein said web site includes marketing information for one or more products or services.

9. The method of claim 2 wherein, upon entering said web site, the individuals are prompted to enter said unique identifier prior to gain access to other pages of said web site.

10. The method of claim 1 wherein said host is a telephone operator and said contact information comprises a telephone number for said operator.

11. The method of claim 10 wherein said operator comprises a host computer running an interactive program for exchanging data with said individuals.

12. A system for marketing and/or conducting a survey amongst individuals attending a common event, said marketing or surveying being conducted by a host, said system comprising:
a) a host capable of being contacted by said individuals over a communication system; and,
b) one or more cards distributed to said individuals, said cards indicating contact information for contacting the host and a unique identifier identifying said event.

13. The system of claim 12 wherein said communication system comprises a computer network and said host comprises a server on said network.

14. The system of claim 13 wherein said computer network comprises the internet and said contact information is a URL address for said server.

15. A system for marketing and/or conducting a survey amongst individuals attending a common event, said system comprising:
a) a computer network;
b) a host conducting said marketing or surveying, said host being connected to said computer network;
c) one or more cards distributed to said individuals, said cards indicating contact information for contacting the host and a unique identifier identifying said event;
d) said host including an interface for exchanging information with said individuals.

16. The system of claim 15 wherein said computer network comprises the internet and said contact information on said cards comprises a URL address for said host.

17. The system of claim 16 wherein said host comprises a server.

18. The system of claim 16 wherein said URL address directs said individuals to a web site for said host.

19. The system of claim 18 wherein said interface on said web site includes a means for obtaining the unique identifier from said individuals.

20. The system of claim 19 wherein, upon entering a valid identifier, the individuals are directed to further pages on said web site.

21. The system of claim 20 wherein said further pages include a means for obtaining demographic data from said individuals.

22. The system of claim 20 wherein said further pages include marketing information for one or more products or services.

23. The system of claim 15 wherein said individuals are provided an incentive for contacting said host.

24. The system of claim 21 wherein said individuals are provided an incentive for contacting said host.

25. The system of claim 22 wherein said individuals are provided an incentive for contacting said host.
